(19) United States
(12) Patent Application Publication
(10) Pub. No.: US 2025/0253413 A1
(43) Pub. Date: Aug. 7, 2025

(54) METHOD FOR PRODUCING LITHIUM ION POWER STORAGE DEVICE, AND LITHIUM ION POWER STORAGE DEVICE

(71) Applicant: Komatsu Ltd., Tokyo (JP)

(72) Inventors: Kenichi Noto, Tokyo (JP); Ryota Kasama, Tokyo (JP); Yuima Kimura, Tokyo (JP); Fumiya Nakamura, Tokyo (JP)

(73) Assignee: Komatsu Ltd., Tokyo (JP)

(21) Appl. No.: 18/855,723

(22) PCT Filed: Jul. 12, 2023
(86) PCT No.: PCT/JP2023/025722

§ 371 Date: Oct. 10, 2024

(30) Foreign Application Priority Data
Jul. 13, 2022 (JP) 2022-112287

(51) Int. Cl. H01M 10/0587; H01M 10/04; H01M 10/0525; H01M 50/107

(52) U.S. Cl. CPC H01M 10/0587; H01M 10/049; H01M 10/0525; H01M 50/107

(57) ABSTRACT

A method for producing a lithium ion power storage device includes a step of forming a cylindrical cell and a step of accommodating the cylindrical cell in a casing. In the step of forming the cylindrical cell, the electrode foil and the separator are wound while applying tension in an extension direction to the laminated electrode foil and separator. In the step of forming the cylindrical cell, the cylindrical cell is formed by winding the electrode foil and the separator into a cylindrical shape. In the step of accommodating the cylindrical cell in the casing, the cylindrical cell is accommodated in a tubular casing together with an electrolytic solution. In the step of forming the cylindrical cell, a cylindrical cell in which a pressure of 0.5 MPa or more and 0.7 MPa or less is applied between the electrode foils facing each other via the separator is formed.

### TECHNICAL FIELD

The present invention relates to a method for producing a lithium ion power storage device and a lithium ion power storage device.

Priority is claimed on Japanese Patent Application No. 2022-112287, filed Jul. 13, 2022, the content of which is incorporated herein by reference.

### BACKGROUND ART

Patent Document 1 discloses a configuration of a lithium ion-based electrochemical device including an electrode group formed by winding a positive electrode and a negative electrode with a separator interposed therebetween, a case accommodating the electrode group, and an organic electrolytic solution which permeates or is impregnated in the electrode group within the case.

### CITATION LIST

### Patent Document

Patent Document 1: Japanese Unexamined Patent Application, First Publication No. 2014-116237

### SUMMARY OF INVENTION

### Technical Problem

The present inventors have found that, when the configuration disclosed in Patent Document 1 is applied to, for example, a lithium-ion capacitor, performing a durability test or the like on the product may cause deposition of lithium on the negative electrode, thereby increasing the deactivation rate of lithium.

The present invention has been made in view of such problems, and an object of the present invention is to provide a method for producing a lithium ion power storage device, in which the deactivation rate of lithium can be reduced and the durability can be improved by suppressing the deposition of lithium, and to provide a lithium ion power storage device.

### Solution to Problem

A method for producing a lithium ion power storage device according to an aspect of the present invention includes a step of forming, by laminating an electrode foil and a separator, each extending in a band shape, and winding a first side in an extension direction of the electrode foil and the separator while applying tension in the extension direction of the laminated electrode foil and separator, a cylindrical cell in which the electrode foil and the separator are wound into a cylindrical shape, and a step of accommodating the cylindrical cell in a tubular casing together with an electrolytic solution, in which, in the step of forming the cylindrical cell, the cylindrical cell in which a pressure of 0.5 MPa or more and 0.7 MPa or less is applied between the electrode foils facing each other through the separator is formed.

A lithium ion power storage device according to an aspect of the present invention includes a cylindrical cell wound in a cylindrical shape in a state in which an electrode foil and a separator, each extending in a band shape, and laminated, and a cylindrical casing that is configured to accommodate the cylindrical cell, in which the cylindrical cell is configured such that tension is applied to the electrode foil and the separator in an extension direction of the electrode foil and the separator, whereby a pressure of 0.5 MPa or more and 0.7 MPa or less is applied between the electrode foils facing each other via the separator.

### ADVANTAGEOUS EFFECTS OF INVENTION

According to the present invention, by suppressing the deposition of lithium, the deactivation rate of lithium can be reduced, and the durability can be improved.

### BRIEF DESCRIPTION OF DRAWINGS

FIG. 1 A cross-sectional view showing a schematic configuration of a power storage device according to an embodiment of the present disclosure.

FIG. 2 A plan view of a cylindrical cell in a developed state according to an embodiment of the present disclosure.

FIG. 3 A cross-sectional view of the cylindrical cell of FIG. 2 in a developed state.

FIG. 4 A side view showing the cylindrical cell of FIG. 2.

FIG. 5 A diagram showing a producing device for a cylindrical cell.

FIG. 6 A flowchart showing a method for producing a lithium ion power storage device according to an embodiment of the present disclosure.

### DESCRIPTION OF EMBODIMENTS

### Embodiment

### <<Configuration of Lithium Ion Power Storage Device>>

Hereinafter, an embodiment will be described in detail with reference to the drawings.

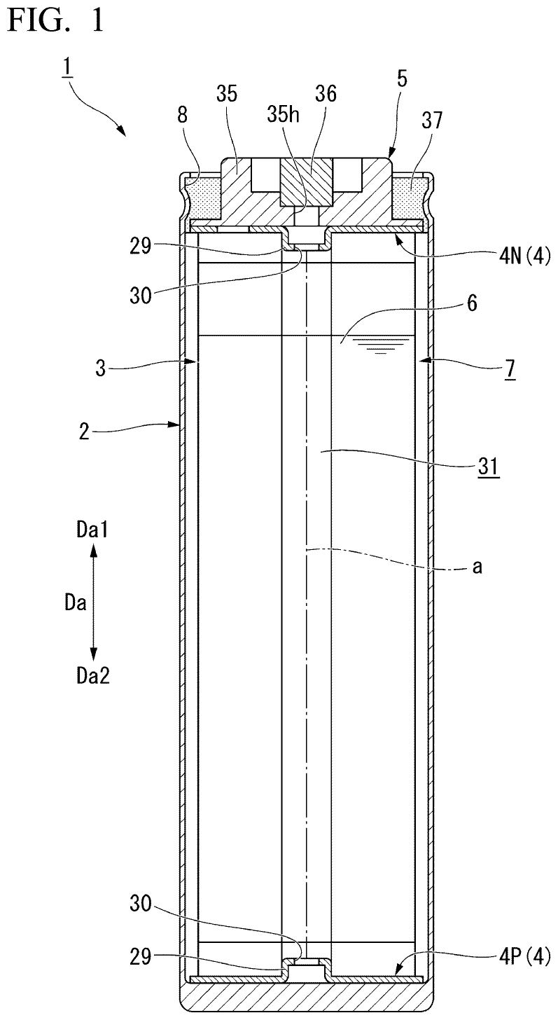

As shown in FIG. 1, a lithium ion power storage device 1 according to the present embodiment will be described using a lithium-ion capacitor (LIC) as an example. That is, the lithium ion power storage device 1 according to the present embodiment has a structure in which an electric double-layer capacitor is used as the positive electrode and a lithium-ion battery is used as the negative electrode.

The lithium ion power storage device 1 includes a casing 2, a cylindrical cell 3, a current collector plate 4, a terminal plate 5, and an electrolytic solution 6.

The casing 2 is made of a metal such as an aluminum alloy and has a bottomed tubular shape. The casing 2 forms an accommodating space 7 that accommodates the cylindrical cell 3, the current collector plate 4, and the electrolytic solution 6. The terminal plate 5 is attached to an opening portion 8 of the casing 2 of the present embodiment by performing a processing such as drawing. The terminal plate 5 closes the opening portion 8.

The cylindrical cell 3 is formed in a cylindrical shape that can be accommodated in the accommodating space 7 of the casing 2. The cylindrical cell 3 formed in a cylindrical shape is accommodated in the accommodating space 7 together with the electrolytic solution 6. A central axis a of the cylindrical cell 3 extends along a central axis of the accommodating space 7 of the casing 2 when accommodated in the accommodating space 7 of the casing 2. In the following description, a direction in which the central axis a (see FIG. 1) of the cylindrical cell 3 extends is referred to as a central axis direction Da, a side where the opening portion 8 of the casing 2 is disposed in the central axis direction Da is referred to as a first side Da1 in the central axis direction, and an opposite side thereof is referred to as a second side Da2 in the central axis direction.

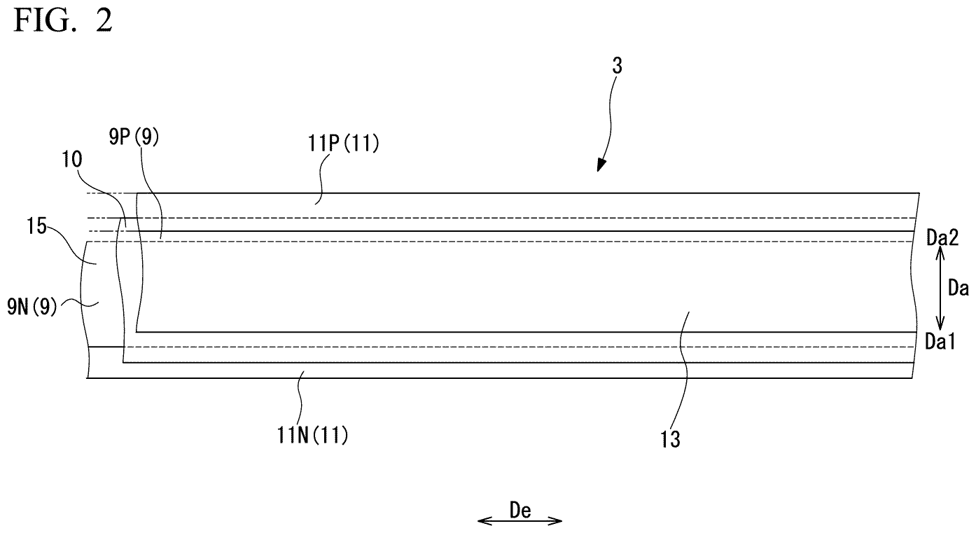

As shown in FIGS. 1 to 4, the cylindrical cell 3 includes a plurality of electrode foils 9, a plurality of separators 10, and a plurality of protruding portions 11. The cylindrical cell 3 is formed by winding the electrode foil 9 and the separator 10 alternately in a cylindrical shape. As shown in FIG. 2, the cylindrical cell 3 includes a positive electrode foil 9P and a negative electrode foil 9N as the electrode foil 9. The cylindrical cell 3 according to the present embodiment includes a positive electrode protruding portion 11P and a negative electrode protruding portion 11N as the protruding portions 11.

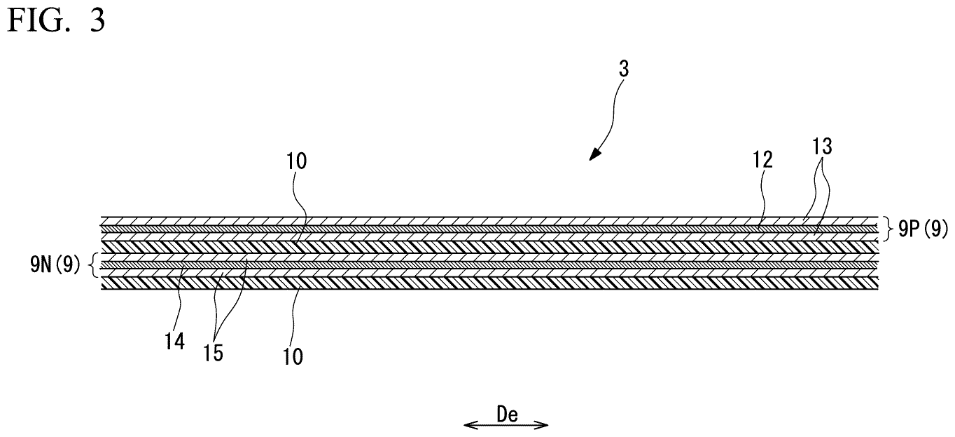

As shown in FIG. 3, the positive electrode foil 9P of the present embodiment includes an aluminum layer 12 formed of an aluminum alloy, and positive electrode carbon material layers 13 formed by coating front and back surfaces of the aluminum layer 12 with a carbon material. The negative electrode foil 9N of the present embodiment includes a copper layer 14 formed of copper, which is a metal having a melting point of 1000° C. or higher, and negative electrode carbon material layers 15 formed by coating front and back surfaces of the copper layer 14 with a carbon material. The aluminum layer 12 and the copper layer 14 have a thickness of, for example, 6 to 20 μm.

The separator 10 consists of an electrically insulating material that maintains at least electrical insulation between the electrodes of the lithium ion power storage device 1. The separator 10 is in a sheet form when the cylindrical cell 3 is unrolled. The separator 10 is disposed between the positive electrode foil 9P and the negative electrode foil 9N. The separator 10 is disposed to sandwich the negative electrode foil 9N. As a result, the positive electrode foil 9P (electrode foil 9), the separator 10, the negative electrode foil 9N (electrode foil 9), and the separator 10 are alternately laminated. The separator 10 has a thickness of, for example, 18 to 22 μm.

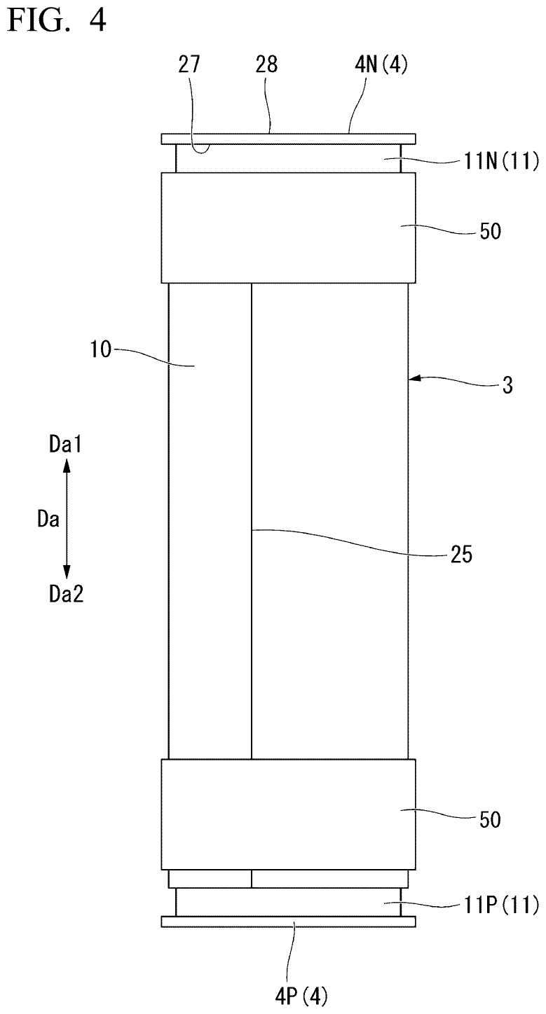

As shown in FIG. 2, the protruding portion 11 is formed integrally with the electrode foil 9. As shown in FIGS. 2 and 4, the cylindrical cell 3 according to the present embodiment includes a negative electrode protruding portion 11N formed on a first side Da1 in the central axis direction and a positive electrode protruding portion 11P formed on a second side Da2 in the central axis direction, as a plurality of protruding portions 11. The positive electrode protruding portion 11P is formed to protrude from the positive electrode foil 9P toward the second side Da2 in the central axis direction. The positive electrode protruding portion 11P protrudes toward the second side Da2 in the central axis direction with respect to the positive electrode foil 9P, the negative electrode foil 9N, and the separator 10. The negative electrode protruding portion 11N is formed to protrude from the negative electrode foil 9N toward the first side Da1 in the central axis direction. The negative electrode protruding portion 11N protrudes toward the first side Da1 in the central axis direction with respect to the positive electrode foil 9P, the negative electrode foil 9N, and the separator 10.

As shown in FIG. 4, the cylindrical cell 3 is formed by winding a positive electrode foil 9P (electrode foil 9), a separator 10, a negative electrode foil 9N (electrode foil 9), and another separator 10, which extend in a band shape, in a laminated state into a cylindrical shape. As a result, the positive electrode foil 9P, the negative electrode foil 9N, and the separator 10 constituting the cylindrical cell 3 form a spiral shape as viewed from the central axis direction Da.

A separator 10 is disposed on the outer peripheral surface of the cylindrical cell 3 formed in this manner. In the present embodiment, an adhesive tape 50 or the like is wound around an edge part of the outer peripheral surface of the cylindrical cell 3 on the first side Da1 in the central axis direction and an edge part of the outer peripheral surface of the cylindrical cell 3 on the second side Da2 in the central axis direction. The end part 25 of the separator 10 is prevented from spreading radially outward with the central axis a as a center by the adhesive tape 50 and the like.

In the cylindrical cell 3, in a state of the cylindrical cell 3 alone, that is, in a state in which the cylindrical cell 3 is not accommodated in the casing 2, a tension is applied to the electrode foil 9 (positive electrode foil 9P and negative electrode foil 9N) and the separator 10 in the direction De (see FIG. 2 and FIG. 3) in which the electrode foil 9 and the separator 10 are extended in a band shape. Due to this tension, a pressure (hereinafter referred to as contact pressure) in the range of 0.5 MPa to 0.7 MPa is applied between the facing electrode foils 9, that is, between the positive electrode foil 9P and the negative electrode foil 9N, via the separator 10.

By applying the tension in the above range to the electrode foil 9 and the separator 10, uniform contact pressure is applied between the positive electrode foil 9P and the negative electrode foil 9N over the entire winding direction of the cylindrical cell 3. As a result, the gap between the positive electrode foil 9P and the negative electrode foil 9N is made uniform over the entire cylindrical cell 3.

Here, in a case where the gap between the positive electrode foil 9P and the negative electrode foil 9N is uneven, a portion where the electrical resistance between the positive electrode foil 9P and the negative electrode foil 9N is locally increased may be generated. In a portion where the electrical resistance is locally large, the overvoltage between the positive electrode foil 9P and the negative electrode foil 9N increases, which is considered to lead to the deposition of lithium (Li) on the negative electrode foil 9N. On the other hand, by appropriately managing the contact pressure between the positive electrode foil 9P and the negative electrode foil 9N over the entire cylindrical cell 3, the gap between the positive electrode foil 9P and the negative electrode foil 9N is made uniform. As a result, variation in electrical resistance between the positive electrode foil 9P and the negative electrode foil 9N is suppressed, and deposition of lithium is suppressed.

In the cylindrical cell 3, in a case where the contact pressure applied between the electrode foils 9 facing each other through the separator 10 is set to be smaller than, for example, 0.5 MPa, the effect of suppressing the deposition of lithium, which is obtained by making the gap between the positive electrode foil 9P and the negative electrode foil 9N uniform is reduced. In addition, in the cylindrical cell 3, in a case where the contact pressure applied between the electrode foils 9 facing each other through the separator 10 is set to be smaller than, for example, 0.5 MPa, the tension acting on the electrode foil 9 and the separator 10 during the production of the cylindrical cell 3 is reduced, and the effect of stably exhibiting the applied contact pressure between the electrode foils 9 is reduced.

In addition, in the cylindrical cell 3, in a case where the contact pressure applied between the electrode foils 9 facing each other through the separator 10 is set to be larger than, for example, 0.7 MPa, the separator 10 interposed between the positive electrode foil 9P and the negative electrode foil 9N may be plastically deformed and crushed, and the gap between the positive electrode foil 9P and the negative electrode foil 9N may be excessively narrowed. In addition, in the cylindrical cell 3, in order to increase the contact pressure applied between the electrode foils 9 facing each other through the separator 10 to be larger than, for example, 0.7 MPa, the tension applied to the electrode foil 9 and the separator 10 during the production of the cylindrical cell 3 excessively increases. In this case, the mechanical strength of the separator 10 may be exceeded, potentially causing adverse effects such as breakage of the separator 10.

In a region on the outer peripheral surface of the cylindrical cell 3 where the ends of the electrode foil 9 and the separator 10 are fixed with the adhesive tape 50, the tension applied to the electrode foil 9 and the separator 10 may be reduced as compared with the inner peripheral portion of the cylindrical cell 3. Therefore, the region in which the predetermined range of contact pressure is applied between the positive electrode foil 9P and the negative electrode foil 9N facing each other through the separator 10 excludes the region facing the outer peripheral surface of the cylindrical cell 3.

When forming the cylindrical cell 3, it is preferable that the appropriate numerical ranges of the tension applied to the electrode foil 9 and the separator 10, as well as the contact pressure applied between the electrode foils 9 facing each other through the separator 10, are set in the prototype stage of the lithium ion power storage device 1, for example, before the lithium ion power storage device 1 is actually produced as a product. For example, when forming the cylindrical cell 3 while applying tension to the electrode foil 9 and the separator 10, pressure-sensitive paper, a pressure sensor, or the like is interposed between the electrode foils 9 facing each other through the separator 10, and the pressure value acting between the electrode foils 9 facing each other through the separator 10 is measured. Using a cylindrical cell 3 in which the pressure value acting between the electrode foils 9 is measured, a long-term storage test and a cycle test in which a load is repeatedly applied are carried out under predetermined conditions. The cylindrical cell 3 after the tests is then evaluated and the presence or absence of lithium deposition is confirmed. As a result, a proper numerical range for the tension applied to the electrode foil 9 and the separator 10, as well as the contact pressure applied between the electrode foils 9 facing each other through the separator 10, may be set based on the condition that the deposition of lithium cannot be confirmed.

In the present embodiment, as shown in FIGS. 1 and 4, the collector plate 4 includes a positive electrode collector plate 4P and a negative electrode collector plate 4N. The negative electrode collector plate 4N is fixed to the negative electrode protruding portion 11N by welding or the like. The positive electrode collector plate 4P is fixed to the positive electrode protruding portion 11P by welding or the like. The positive electrode collector plate 4P and the negative electrode collector plate 4N are formed in a substantially flat plate shape having a circular outer edge about the central axis a, and have an inner surface 27 facing the protruding portion 11 side in the central axis direction Da and an outer surface 28 facing a side opposite to the inner surface 27 to be back to back in the central axis direction Da.

The positive electrode collector plate 4P is formed of a metal containing the same metal as the positive electrode protruding portion 11P. That is, the positive electrode collector plate 4P of the present embodiment is formed of an aluminum alloy. The negative electrode collector plate 4N is formed of a metal containing the same metal as the negative electrode protruding portion 11N. The negative electrode collector plate 4N is formed of a material having a melting point of 1000° C. or higher. The negative electrode collector plate 4N of the present embodiment is made of copper. As shown in

FIG. 1, a projection portion 29 that protrudes toward the protruding portion 11 side in the central axis direction Da is formed in a central portion of the collector plate 4 in the present embodiment. Furthermore, a through hole 30 is formed in the projection portion 29 of the collector plate 4. The projection portion 29 is inserted into a cavity portion 31 with a circular cross-section, formed at the central portion of the cylindrical cell 3 and extending in the central axis direction Da.

As shown in FIG. 1, the terminal plate 5 closes the opening portion 8 of the casing 2. The terminal plate 5 of the present embodiment includes at least a terminal plate body 35, a pressure regulating valve 36, and a sealing rubber 37. The terminal plate body 35 has a circular shape when viewed from the central axis direction Da, and has a hole 35h in a central portion thereof. The pressure regulating valve 36 is disposed in the central portion of the terminal plate body 35 and regulates a pressure in the accommodating space 7 through the hole 35h. The sealing rubber 37 seals a gap between the terminal plate body 35 and an inner peripheral surface of the opening portion 8 of the casing 2. The pressure regulating valve 36 is attached to close the hole 35h after the electrolytic solution 6 is injected into the accommodating space 7 through the hole 35h of the terminal plate body 35.

### <<Configuration of Cylindrical Cell Producing Device>>

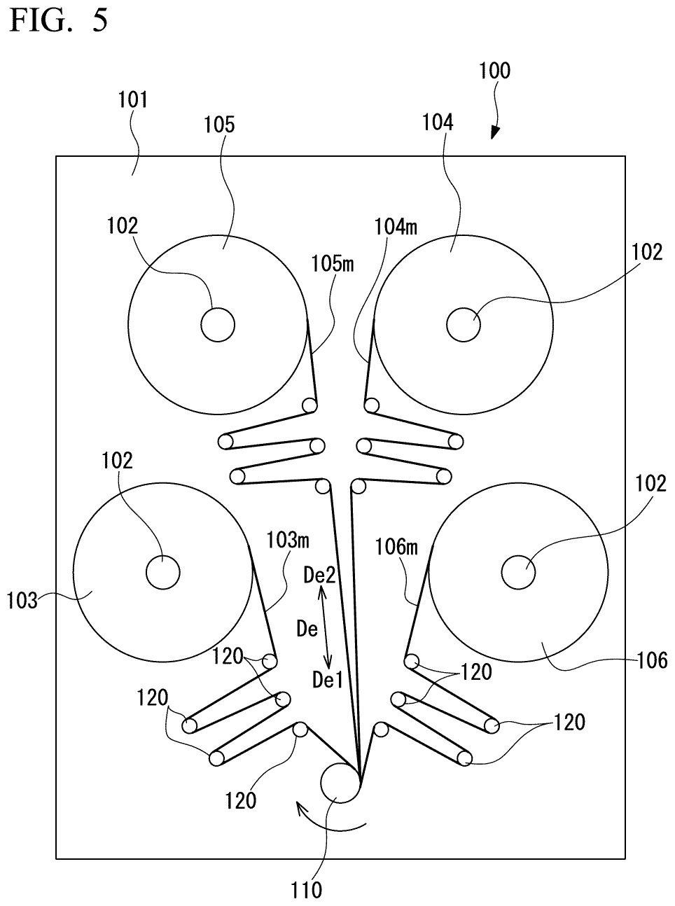

The cylindrical cell 3 as described above is produced by a producing device 100 as shown in FIG. 5. The producing device 100 includes a device base portion 101, a plurality of roll support portions 102, a winding roller 110, and a plurality of intermediate guides 120.

The plurality of roll support portions 102 are supported by the device base portion 101. Each of the plurality of roll support portions 102 rotatably supports the positive electrode foil 9P (and the positive electrode protruding portion 11P), the negative electrode foil 9N (and the negative electrode protruding portion 11N), and raw material rolls 103, 104, 105, and 106 of the two sets of separators 10. The raw material roll 103 is formed by winding a positive electrode material 103m, which extends in a band shape, into a roll shape to form the positive electrode foil 9P (and the positive electrode protruding portion 11P). The raw material roll 104 is formed by winding a negative electrode material 104m, which extends in a band shape, into a roll shape to form the negative electrode foil 9N (and a negative electrode protruding portion 11N). The raw material rolls 105 and 106 are each formed by rolling a separator material 105m and a separator material 106m, which extend in a band shape to form the separator 10, into a roll shape. The positive electrode material 103m, the negative electrode material 104m, and the separator materials 105m and 106m are each fed from each of the raw material rolls 103, 104, 105, and 106 on the second side De2 in the extension direction De. The positive electrode material 103m, the negative electrode material 104m, and the separator materials 105m and 106m fed out are guided by the plurality of intermediate guides 120 and are supplied to the winding roller 110.

The winding roller 110 is rotatably supported by the device base portion 101. The winding roller 110 is rotationally driven by a motor (not shown). The winding roller 110 winds the positive electrode material 103m fed from the raw material roll 103, the separator material 105m fed from the raw material roll 105, the negative electrode material 104m fed from the raw material roll 104, and the separator material 106m fed from the raw material roll 106 in a laminated state. The winding roller 110 forms the cylindrical cell 3 by winding the first side De1 of the positive electrode material 103m, the separator material 105m, the negative electrode material 104m, and the separator material 106m, each of which extend in a band shape, in the extension direction De into a cylindrical shape.

The plurality of intermediate guides 120 are disposed between the portions of the raw material rolls 103, 105, 104, and 106 from which the positive electrode material 103m, the separator material 105m, the negative electrode material 104m, and the separator material 106m are fed, and the winding roller 110 that winds the positive electrode material 103m, the separator material 105m, the negative electrode material 104m, and the separator material 106m. The plurality of intermediate guides 120 are each disposed at a plurality of positions along a movement path of the positive electrode material 103m, the separator material 105m, the negative electrode material 104m, and the separator material 106m fed from the raw material rolls 103, 105, 104, and 106. Each intermediate guide 120 is supported by the device base portion 101.

Each of the intermediate guides 120 is in contact with the surfaces of the positive electrode material 103m, the separator material 105m, the negative electrode material 104m, and the separator material 106m. Each of the intermediate guides 120 presses each of surfaces of the positive electrode material 103m, the separator material 105m, the negative electrode material 104m, and the separator material 106m in a direction intersecting the extension direction De in which the positive electrode material 103m, the separator material 105m, the negative electrode material 104m, and the separator material 106m extend in a band shape. The positive electrode material 103m, the separator material 105m, the negative electrode material 104m, and the separator material 106m are each pressed by each of the intermediate guides 120, whereby tension in the direction along the extension direction De of the positive electrode material 103m, the separator material 105m, the negative electrode material 104m, and the separator material 106m is applied.

Here, each of the intermediate guides 120 may be configured to press the positive electrode material 103m, the separator material 105m, the negative electrode material 104m, and the separator material 106m by an elastic member such as a spring, or by air pressure, oil pressure, or the like. In addition, the intermediate guide 120 may be rotatably supported by the device base portion 101.

### <<Method for Producing Lithium Ion Power Storage Device>>

A method for producing the above-described lithium ion power storage device will be described.

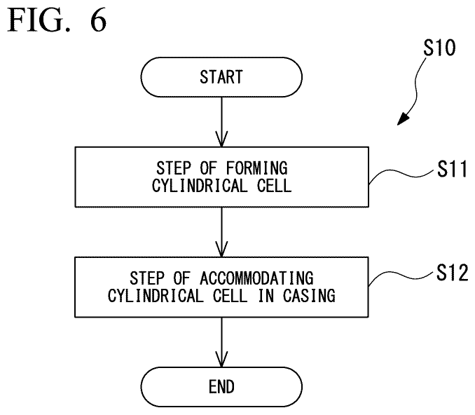

As shown in FIG. 6, the method S10 for producing a lithium ion power storage device includes a step S11 of forming a cylindrical cell 3 and a step S12 of accommodating the cylindrical cell 3 in the casing 2.

In step S11 of forming the cylindrical cell 3, the electrode foil 9 and the separator 10 are laminated, and while applying tension in the extension direction De of the laminated electrode foil 9 and separator 10, the first side De1 of the electrode foil 9 and the separator 10 in the extension direction De is wound. For this, for example, the producing device 100 described above is used. The positive electrode material 103m (electrode foil 9), the separator material 105m (separator 10), the negative electrode material 104m (electrode foil 9), and the separator material 106m (separator 10) are fed from each of the raw material rolls 103, 105, 104, and 106. These materials are then laminated by being joined either by the winding roller 110 or at a position in front of the winding roller 110. The laminated positive electrode material 103m, the separator material 105m, the negative electrode material 104m, and the separator material 106m are wound by the winding roller 110 on the first sides De1 in each of the extension directions De. In the producing device 100, at the stage where the positive electrode material 103m, the separator material 105m, the negative electrode material 104m, and the separator material 106m are wound to a predetermined length, the positive electrode material 103m, the separator material 105m, the negative electrode material 104m, and the separator material 106m fed from the raw material rolls 103, 105, 104, and 106 are cut by a cutting mechanism (not shown). The ends of the cut positive electrode material 103m, separator material 105m, negative electrode material 104m, and separator material 106m are fixed to the outer peripheral surface of the cylindrical cell 3 by the adhesive tape 50. In this manner, the cylindrical cell 3 is formed.

When the positive electrode material 103m, the separator material 105m, the negative electrode material 104m, and the separator material 106m are wound around the winding roller 110, tension is applied to each of the positive electrode material 103m, the separator material 105m, the negative electrode material 104m, and the separator material 106m. This tension can be adjusted by the plurality of intermediate guides 120 disposed on the movement path of the positive electrode material 103m, the separator material 105m, the negative electrode material 104m, and the separator material 106m.

By making the positive electrode material 103m, the separator material 105m, the negative electrode material 104m, and the separator material 106m meander, each of the intermediate guides 120 presses each of the surfaces of the positive electrode material 103m, the separator material 105m, the negative electrode material 104m, and the separator material 106m in a direction intersecting the extension direction De in which the positive electrode material 103m, the separator material 105m, the negative electrode material 104m, and the separator material 106m extend in a band shape. In addition, the position of each intermediate guide 120 is movable, and the tension of each of the positive electrode material 103m, the separator material 105m, the negative electrode material 104m, and the separator material 106m can be adjusted by moving the position of each intermediate guide 120. Each intermediate guide 120 may be configured to adjust the pressing force on the positive electrode material 103m, the separator material 105m, the negative electrode material 104m, and the separator material 106m using an elastic member such as a spring, or with air pressure, oil pressure, or the like, whereby the tension of the positive electrode material 103m, the separator material 105m, the negative electrode material 104m, and the separator material 106m may be adjustable.

In this manner, by winding the laminated positive electrode material 103m, separator material 105m, negative electrode material 104m, and separator material 106m while applying tension, the cylindrical cell 3 is formed in a state where contact pressure is applied between the electrode foils 9 (the positive electrode foil 9P and the negative electrode foil 9N) facing each other through the separator 10, before being accommodated in the casing 2.

In step S12 of accommodating the cylindrical cell 3 in the casing 2, the cylindrical cell 3 formed in step S11 is accommodated in the casing 2. Prior to this, the collector plate 4 is welded to the protruding portion 11 of the cylindrical cell 3. The structural body in which the protruding portion 11 and the collector plate 4 are joined is accommodated in the casing 2 after the terminal plate body 35 is welded to the collector plate 4. Thereafter, the opening portion 8 of the casing 2 is closed by the sealing rubber 37 of the terminal plate 5, the electrolytic solution 6 is injected through the hole 35h of the terminal plate body 35, and the pressure regulating valve 36 is attached. As a result, a lithium ion power storage device 1 is produced.

### Operating Effects

In the method S10 for producing the lithium ion power storage device 1 and the lithium ion power storage device 1, by applying tension to the electrode foil 9 and the separator 10 of the cylindrical cell 3, a uniform contact pressure of 0.5 MPa or more and 0.7 MPa or less is applied between the positive electrode foil 9P and the negative electrode foil 9N, which are constituting the cylindrical cell 3, over the entire winding direction of the cylindrical cell 3. As a result, the gap between the positive electrode foil 9P and the negative electrode foil 9N is made uniform over the entire cylindrical cell 3. Therefore, the contact pressure between the positive electrode foil 9P and the negative electrode foil 9N is properly managed, and the variation in electrical resistance between the positive electrode foil 9P and the negative electrode foil 9N is suppressed. As a result, deposition of lithium on the electrode foil 9 (negative electrode foil 9N) is suppressed.

Therefore, by suppressing the deposition of lithium, the deactivation rate of lithium can be reduced, and the durability of the lithium ion power storage device 1 can be improved. As a result, particularly, even when a large current flows through the lithium ion power storage device 1, high durability can be maintained.

Further, in the cylindrical cell 3, at a stage before being accommodated in the casing 2, a predetermined range of contact pressure is applied between the electrode foils 9 facing each other through the separator 10. As another method of applying the contact pressure between the electrode foils 9, there is a method of applying the contact pressure from the casing 2 to the cylindrical cell 3 by press-fitting the cylindrical cell 3 into the casing 2. However, in such another method, the portion where the contact pressure is applied from the casing 2 to the cylindrical cell 3 is limited to the portion where the cylindrical cell 3 and the casing are in contact with each other. Therefore, for example, in a case where the cylindrical cell 3 is pressed into the casing 2 having a square tubular shape, the distribution of the contact pressure applied from the casing 2 to the cylindrical cell 3 becomes uneven. In addition, it takes time and effort to press-fit the cylindrical cell 3 into the casing 2.

On the other hand, in the method S10 for producing the lithium ion power storage device 1, since the contact pressure is applied between the electrode foils 9 before the cylindrical cell 3 is accommodated in the casing 2, it is possible to easily apply a uniform contact pressure between the electrode foils 9 over the entire winding direction of the cylindrical cell 3. In addition, since such a cylindrical cell 3 does not need to be press-fitted into the casing 2, the assembly work can be easily performed.

Further, by pressing the electrode foil 9 and the separator 10 in a direction intersecting the extension direction De of the electrode foil 9 and the separator 10 with the intermediate guide 120, it is possible to apply tension to the electrode foil 9 and the separator 10 with a simple configuration.

### EXAMPLES

Since the cylindrical cell 3 was formed by the method S10 for producing the lithium ion power storage device 1 as described above, and the deposition state of lithium was confirmed, the results are shown below.

The cylindrical cell 3 was produced such that a contact pressure of 0.5 MPa was applied between the positive electrode foil 9P and the negative electrode foil 9N. For comparison, cells were prepared in which the contact pressure acting between the positive electrode foil 9P and the negative electrode foil 9N was 0.01 MPa (Comparative Example 1) or 0.04 MPa (Comparative Example 2).

For each of the cylindrical cell 3 of the Examples and the cells of Comparative Examples 1 and 2, a cycle test was carried out in which the temperature was 80° C., the test time was 160 hours, and the test voltage was varied between 2.8 V and 3.95 V to repeat charging and discharging. As a result, in the cylindrical cell 3 where a contact pressure of 0.5 MPa was applied between the positive electrode foil 9P and the negative electrode foil 9N, no deposition of lithium was observed. On the other hand, in Comparative Examples 1 and 2, where the contact pressure was set to 0.01 MPa and 0.04 MPa, the deposition of lithium was observed on the negative electrode foil 9N.

### Other Embodiments

Hereinabove, the embodiment of the present invention has been described. However, the present invention is not limited thereto and can be suitably modified without departing from the technical idea of the invention.

In the above-described embodiment, the configuration is adopted in which tension is applied to the electrode foil 9 and the separator 10 by the intermediate guide 120, but the present disclosure is not limited to this. For example, in the roll support portion 102 that supports the raw material rolls 103 to 106, a torque in a direction opposite to the direction in which the electrode foil 9 and the separator 10 are fed out from the raw material rolls 103 to 106 may be applied to the raw material rolls 103 to 106 to apply tension to the electrode foil 9 and the separator 10.

### Industrial Applicability

According to the present invention, by suppressing the deposition of lithium, the deactivation rate of lithium can be reduced, and the durability can be improved.

### REFERENCE SIGNS LIST

1: Lithium ion power storage device
2: Casing
3: Cylindrical cell
6: Electrolytic solution
9: Electrode foil
10: Separator

1. A method for producing a lithium ion power storage device, the method comprising:
a step of forming, by laminating an electrode foil and a separator, each extending in a band shape, and winding a first side in an extension direction of the electrode foil and the separator while applying tension in the extension direction of the laminated electrode foil and separator, a cylindrical cell in which the electrode foil and the separator are wound into a cylindrical shape; and
a step of accommodating the cylindrical cell in a tubular casing together with an electrolytic solution,
wherein, in the step of forming the cylindrical cell, the cylindrical cell in which a pressure of 0.5 MPa or more and 0.7 MPa or less is applied between the electrode foils facing each other through the separator is formed.

2. The method for producing a lithium ion power storage device according to claim 1,
wherein, in the step of forming the cylindrical cell, tension is applied to the electrode foil and the separator by pressing the electrode foil and the separator in a direction intersecting the extension direction of the electrode foil and the separator, between a portion where the electrode foil and the separator are fed out on a second side in the extension direction of the electrode foil and the separator, and a portion where the electrode foil and the separator are wound on the first side in the extension direction of the electrode foil and the separator.

3. A lithium ion power storage device comprising:
a cylindrical cell wound in a cylindrical shape in a state in which an electrode foil and a separator, each extending in a band shape, and laminated; and
a cylindrical casing that is configured to accommodate the cylindrical cell,
wherein the cylindrical cell is configured such that tension is applied to the electrode foil and the separator in an extension direction of the electrode foil and the separator, whereby a pressure of 0.5 MPa or more and 0.7 MPa or less is applied between the electrode foils facing each other via the separator.
